(19) United States
(12) Patent Application Publication
(10) Pub. No.: US 2004/0136350 A1
(43) Pub. Date: Jul. 15, 2004

(54) Bluetooth data transmission system having a plurality of secondary terminals

(76) Inventor: Michael Warmers, Erkelenz (DE)

Correspondence Address: LERNER AND GREENBERG, PA, P O BOX 2480, HOLLYWOOD, FL, 33022-2480, US

(21) Appl. No.: 10/720,929

(22) Filed: Nov. 24, 2003

Related U.S. Application Data
(63) Continuation of application No. PCT/DE02/01430, filed on Apr. 17, 2002.

(30) Foreign Application Priority Data
May 23, 2001 (DE) 101 25 342.7

(51) Int. Cl. H04Q 7/24; H04J 3/24

(52) U.S. Cl. 370/338; 370/349

(57) ABSTRACT

A Bluetooth data transmission system has a primary terminal, a first group of secondary terminals and a second group of secondary terminals. Data packets can be interchanged by radio between the primary terminal and the secondary terminals in the first group and the secondary terminals in the second group. For connection identification with the first group and with the second group, the primary terminal has a first address and a second address.

### CROSS-REFERENCE TO RELATED APPLICATIONS

This application is a continuation of copending International Application No. PCT/DE02/01430, filed Apr. 17, 2002, which designated the United States and was not published in English.

### BACKGROUND OF THE INVENTION

1. Field of the Invention

The invention relates to a data transmission system operating on the basis of the Bluetooth standard. The data transmission system contains a primary terminal (master) and secondary terminals (slaves). Data packets are interchanged by radio between the primary terminal and the secondary terminal on the basis of a timeslot method.

Such data transmission systems, in which data packets are transmitted by radio over just short distances, are referred to as piconetworks. Piconetworks based on the Bluetooth standard are known which have a primary terminal and a number of secondary terminals, the number of secondary terminals being limited to a maximum of seven secondary terminals. This limitation relates only to the secondary terminals that are actively involved in the piconetwork in question, however. In addition, the piconetwork can have an almost unlimited number (up to 2⁴⁸) of further secondary terminals that are in a standby mode (parked state) and are not actively involved in the data interchange within the piconetwork. However, operating a secondary terminal in standby mode has drawbacks. The drawbacks include the increased protocol complexity for maintaining a secondary terminal in standby mode and the reduced reachability of a terminal that is in the standby mode, as it can be reached only in particular time intervals.

Data transmission from the primary terminal to the secondary terminals is called a downlink. The converse case of data transmission from the secondary terminals to the primary terminal is called an uplink. Normally, timeslot methods are used for the data transmission. With timeslot methods, the downlink and the uplink are assigned timeslots (slots) of a particular duration.

The frequencies available for data transmission in piconetworks are stipulated by the industrial, scientific and medical (ISM) frequency bands. The ISM frequency bands are reserved for the radio-oriented, unlicensed application of weak transmission power. By way of example, Bluetooth data transmission systems operate in a frequency band around 2.4 GHz.

For the use of the ISM frequency bands, the regulating authority, the Federal Communications Commission (FCC), has established rules governing the way in which data interchange is to take place. One rule states that wireless data transmission is to be performed on the basis of a frequency hopping method (frequency hopping spread spectrum (FHSS)). In this case, the channel center frequency in which data transmission takes place needs to be varied after a particular period of time.

In the Bluetooth standard, each primary and secondary terminal has an address that can be used to identify it (in this regard, see also the Bluetooth specifications on the Internet at http://www.bluetooth.com). Such an address BD_ADDR is shown in a diagram in FIG. 1. The address BD_ADDR is made up of three address fields: an address field LAP (Lower Address Part) containing 24 bits, an address field UAP (Upper Address Part) containing 8 bits, and an address field NAP (Non-Significant Address Part) containing 16 bits. A Bluetooth piconetwork is characterized by the address BD_ADDR of the associated primary terminal. The address field LAP of the primary terminal determines both the time sequence for the channel center frequencies and identification information which is referred to as the channel access code (CAC) and which the primary and secondary terminals in a piconetwork use to identify such data packets as are transmitted within the piconetwork in question. The identification information is derived from the address field LAP of the primary terminal and always indicates a data packet that is to be transmitted in the piconetwork. All data packets interchanged within a piconetwork are indicated by the same identification information.

### SUMMARY OF THE INVENTION

It is accordingly an object of the invention to provide a Bluetooth data transmission system having a plurality of secondary terminals that overcomes the above-mentioned disadvantages of the prior art devices of this general type, which is based on the Bluetooth standard and has a primary terminal and a plurality of secondary terminals where the data transmission system is intended to be configured for more than seven secondary terminals which are actively involved in the data transmission system and are not in a standby mode.

With the foregoing and other objects in view there is provided, in accordance with the invention, a data transmission system based on the Bluetooth standard. The data transmission system contains a primary terminal and a first group of secondary terminals. Data packets are interchanged by radio between the primary terminal and the first group of secondary terminals with a first address of the primary terminal being used for connection identification. A second group of the secondary terminals are also provided. Data packets are interchanged by radio between the primary terminal and the second group of the secondary terminals with a second address of the primary terminal being used for connection identification.

An inventive data transmission system that is based on the Bluetooth standard contains a primary terminal and a first group of secondary terminals. Data packets are interchanged by radio between the primary terminal and the secondary terminals in the first group. For the purpose of connection identification between the primary terminal and the secondary terminals in the first group, a first address of the primary terminal is used. A fundamental concept of the invention is that the data transmission system also has a second group of secondary terminals that are likewise configured for wirelessly interchanging data packets with the primary terminals. For the purpose of connection identification between the primary terminal and the secondary terminals in the second group, a second address for the primary terminal is used.

The advantage of the inventive data transmission system is that it is possible to connect more than seven active secondary terminals to a primary terminal simultaneously. In the Bluetooth standard, the first and the second group can each have up to seven active secondary terminals. In line with the invention, a dedicated address for the primary terminal is available for each group's data transmission with the primary terminal. In Bluetooth data transmission systems to date, it has been possible to connect to more than seven secondary terminals only on condition that no more than seven secondary terminals are in active contact with the primary terminal, and the remaining secondary terminals are in standby mode. This condition is eliminated in the case of the present invention.

In one advantageous refinement of the invention, the first and second addresses differ in at least one bit. Therefore, it is possible to use the Bluetooth address BD_ADDR of the primary terminal for the first and second addresses, for example. By changing over the at least one bit from 0 to 1 or from 1 to 0, it is possible to generate the second address from the first address, and vice versa.

Advantageously, the at least one bit is situated in a prescribed address field which, in particular, is the address field referred to as the lower address part (LAP) in the Bluetooth standard. The address field referred to as the lower address part always indicates an address in the Bluetooth standard. From the address field for the primary terminal, identification information used to identify the secondary terminal in a group with the primary terminal is derived. For this reason, implementation of the at least one bit in which the first and second addresses differ in this address field is particularly advantageous. By way of example, the at least one bit can be the least significant bit (LSB), which indicates the first and second addresses of the primary terminal.

In line with another advantageous refinement of the invention, a data packet of identification information is indicated from which, in the case of a downlink, on the one hand, the secondary terminals deduce the group of secondary terminals for which the data packet is intended, or in the case of an uplink, on the other hand, the primary terminal can determine the group of secondary terminals from which the data packet has been sent. This measure allows a clear distinction to be drawn between the data packets from the first group and the data packets from the second group. Normally, the identification information is obtained from the address field of the primary terminal referred to as the lower address part. In addition, the first and second groups are limited to seven of the secondary terminals each.

To initialize a data transmission system in the Bluetooth standard, the primary terminal is in a “Page” sub-state and the secondary terminals are in “Page Scan” sub-states. In these sub-states, initialization information can be interchanged between the primary terminal and the secondary terminals. Only thereafter are the secondary terminals clearly defined. To be able to distinguish between the secondary terminals in the first group and the secondary terminals in the second group even before such initialization, all secondary terminals advantageously have devices (memories, filters etc.) that stipulate their membership of one of the two groups.

The inventive data transmission system can be used, by way of example, in short-range digital cordless communication systems, such as cordless telephones having a plurality of mobile parts. Another application relates to data interchange between a computer and peripheral devices, such as a mouse, a printer or a scanner.

Another aspect of the invention relates to a primary terminal that has a first address and a second address. The primary terminal is integrated in a data transmission system having the features described above. One advantage of such a primary terminal is that it can communicate with secondary terminals from two piconetworks, each piconetwork being able to have up to seven secondary terminals in the Bluetooth standard.

Other features which are considered as characteristic for the invention are set forth in the appended claims.

Although the invention is illustrated and described herein as embodied in a Bluetooth data transmission system having a plurality of secondary terminals, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of an address for a primary or secondary terminal on the basis of the Bluetooth standard according to the prior art; and

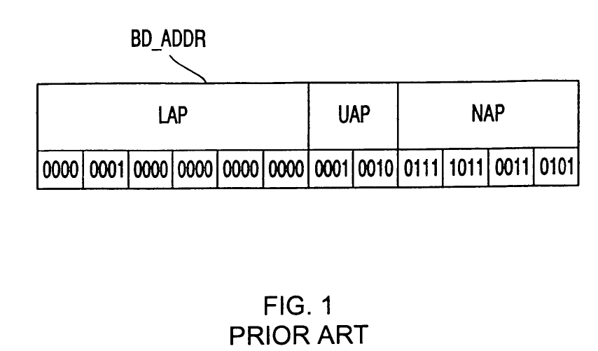

FIG. 2 is an illustration of an exemplary embodiment of a data transmission system according to the invention.

### DESCRIPTION OF THE PREFERRED EMBODIMENTS

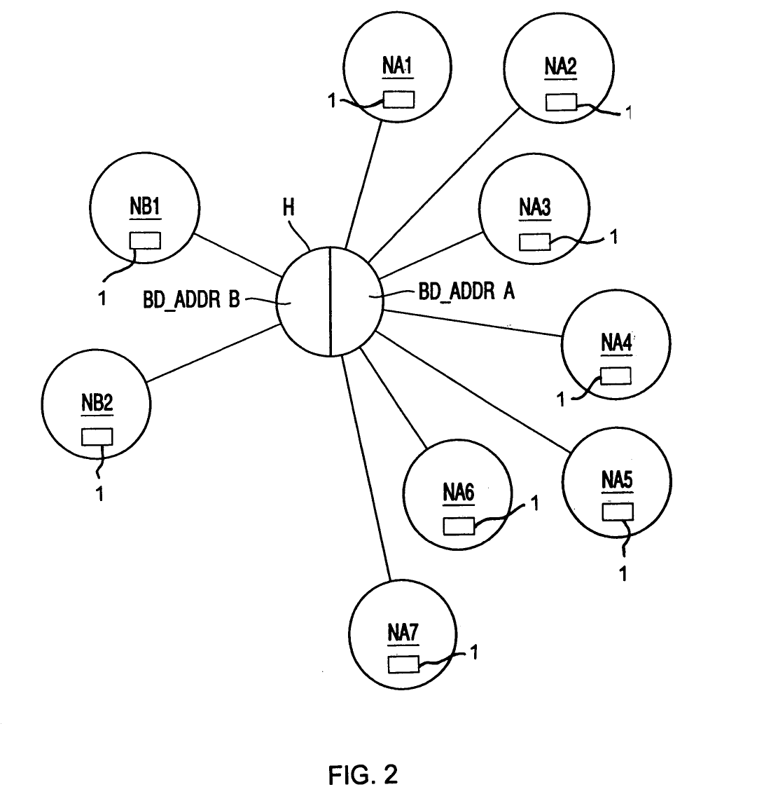

Referring now to the figures of the drawing in detail and first, particularly, to FIG. 2 thereof, there is shown schematically an exemplary embodiment of an inventive data transmission system. Data packets can be interchanged by radio between a primary terminal H and secondary terminals NAi and NBi (i=1, . . . , 7) on the basis of the Bluetooth standard. In this case, the data transmission can take place bi-directionally from the primary terminal H to the secondary terminals NAi and NBi, and vice versa. The possible downlinks and uplinks are identified by connecting lines in FIG. 2.

The wireless connections between the primary terminal H and the secondary terminals NAi are characterized by an address BD_ADDR A for the primary terminal H. From the address BD_ADDR A, identification information is derived which is indicated in each data packet interchanged between the primary terminal H and the secondary terminals NAi.

In a similar manner to the address BD_ADDR A, an address BD_ADDR B for the primary terminal H characterizes the communication between the primary terminal H and the secondary terminals NBi.

In the present exemplary embodiment of the invention, there are seven secondary terminals NAi and two secondary terminals NBi. On the basis of the Bluetooth standard, an address BD_ADDR A or BD_ADDR B for the primary terminal H can relate only to a piconetwork having up to seven secondary terminals. Consequently, another five secondary terminals NBi could be added to the existing secondary terminals NAi and NBi.

Provision can also be made for the primary terminal H to interchange data packets with more than fourteen active secondary terminals. This would require, besides the addresses BD_ADDR A and BD_ADDR B, further addresses to be generated for the primary terminal H in order to satisfy the Bluetooth standard.

To be able to distinguish between the secondary terminals NAi in the first group and the secondary terminals in the second group NBi even before initialization, all secondary terminals advantageously have devices 1 (memories, filters etc.) that stipulate their membership of one of the two groups.

I claim:

1. A data transmission system based on a Bluetooth standard, the data transmission system comprising:
a primary terminal;
a first group of secondary terminals, data packets being interchanged by radio between said primary terminal and said first group of secondary terminals with a first address of said primary terminal being used for connection identification; and
a second group of said secondary terminals, data packets being interchanged by radio between said primary terminal and said second group of said secondary terminals with a second address of said primary terminal being used for connection identification.

2. The data transmission system according to claim 1, wherein the first address and the second address differ in at least one bit.

3. The data transmission system according to claim 2, wherein the at least one bit in which the first address and the second address differ is situated in a prescribed address field.

4. The data transmission system according to claim 3, wherein the at least one bit in which the first address and the second address differ is a least significant bit in the prescribed address field.

5. The data transmission system according to claim 1, wherein said first group of said secondary terminals and said second group of said secondary terminals each have up to seven of said secondary terminals.

6. The data transmission system according to claim 1, wherein the data packet contains identification information for indicating a respective group with which the data packet is to be interchanged with.

7. The data transmission system according to claim 1, wherein said first group of said secondary terminals and said second group of said secondary terminals have devices for stipulating their membership to said first group of said secondary terminals or said second group of said secondary terminals.

8. The data transmission system according to claim 1, wherein the data transmission system can be used in digital cordless communication systems and in computer-controlled systems with peripheral devices.

9. The data transmission system according to claim 1, wherein said primary terminal has a first address and a second address.

10. The data transmission system according to claim 3, wherein the prescribed address field is a lower address part of an address field.

11. A primary terminal configuration for a data transmission system, the primary terminal configuration comprising:
a primary terminal having a first address and a second address.
